(19) United States
(12) Patent Application Publication
(10) Pub. No.: US 2010/0147026 A1
(43) Pub. Date: Jun. 17, 2010

(54) METHOD OF PRODUCING INDEPENDENT GLASS FILMS

(76) Inventor: Toshihiro Kasai, Kanagawa (JP)

Correspondence Address: 3M INNOVATIVE PROPERTIES COMPANY, PO BOX 33427, ST. PAUL, MN, 55133-3427, US

(21) Appl. No.: 12/598,777

(22) PCT Filed: Jun. 11, 2008
(86) PCT No.: PCT/US08/66548

§ 371 Date: Nov. 4, 2009

(30) Foreign Application Priority Data
Jun. 26, 2007 (JP) 2007-167522

(51) Int. Cl. C03C 14/00; C03B 8/00

(52) U.S. Cl. 65/17.2; 501/32

(57) ABSTRACT

Methods for producing an independent glass ceramic film including the steps of mixing a colloidal silica sol having a pH of about 4 or less, a zirconium-containing compound, a binder, and a crosslinking agent capable of crosslinking with the binder at about 50° C. or less, to produce a mixed liquid; coating the mixed liquid on a substrate; drying the coated mixed liquid to form a precursor film on the substrate; separating the precursor film from the substrate; and firing the separated precursor film. A precursor liquid that includes colloidal silica sol having a pH of about 4 or less, a zirconium-containing compound, a binder, and a crosslinking agent capable of crosslinking with the binder at about 50° C. or less is also disclosed.

### RELATED APPLICATION

This application claims priority to pending Japanese Patent Application No. 2007-167522, filed on Jun. 26, 2007, the disclosure of which is incorporated by reference in its entirety herein.

### FIELD

The present disclosure relates to methods of producing glass films.

### BACKGROUND

Sol gel methods are commonly utilized to produce metal oxide or hydroxide sols from solutions containing organic metal compounds or inorganic compounds such as metal alkoxides by gelling the sol and subsequently heating the gel to produce a ceramic or glass.

Methods of producing SiO₂ glass using sol-gel techniques are also known to those of skill in the art. Many of these methods however can only produce coatings of 1 micrometer (μm) or less that are integral to a substrate, e.g. a glass or conductive substrate. Methods of producing SiO₂ glass films that are separable from a substrate using sol-gel methods generally require highly-specialized drying (e.g. supercritical drying) in order to prevent cracks from forming during drying. If supercritical drying is not utilized, drying must be carried out very slowly.

For example, Japanese Unexamined Patent Publication (Kokai) No. 61-236619 describes a method of producing quartz glass using a sol-gel method, where the sol is dried at 20° C. for one night followed by further drying at 60° C. for 10 days using a drying vessel with a cover having a predetermined open ratio.

Also, Japanese Unexamined Patent Publication (Kokai) No. 4-292425) teaches a method for producing silica glass using a sol-gel method, where the raw material sol is placed in a Petri dish, and gelled at room temperature, after which the cover of the Petri dish is replaced by a perforated cover and the gel is then dried at 60° C. for 100 days.

Such extended drying times render these production methods impractical. Even though films produced using these methods can be separated from the substrate on which they are formed, they are not free standing and require a support. The above discussed methods also generally require that the film be fired after drying to obtain a final film. Firing usually causes the film to shrink, which in turn causes deformation or cracking of the glass film. Shrinkage during firing can also result in curling of the film. Given the considerations discussed above, there remains a need for practical methods of producing SiO₂ films that do not require a support (referred to herein as “independent” films), that are not cracked, and that don't deform.

### SUMMARY

In an embodiment, an exemplary method for producing an independent glass ceramic film includes the steps of mixing a colloidal silica sol adjusted to a pH of 4 or less, a zirconium-containing compound, a binder, and a crosslinking agent capable of crosslinking with the binder at 50° C. or less, to produce a mixed liquid; coating the mixed liquid on a substrate; drying the coated mixed liquid to form a precursor film on the substrate; separating the precursor film from the substrate; and firing the separated precursor film.

In an embodiment, a precursor mixture for the production of an independent glass ceramic film is provided. The precursor mixture can be obtained by mixing a colloidal silica sol adjusted to a pH of 4 or less, a zirconium-containing compound, a binder, and a 2 0 crosslinking agent capable of crosslinking with the binder at 50° C. or less.

### BRIEF DESCRIPTION OF THE DRAWINGS

FIG. 1 shows an X-ray diffraction (XRD) pattern of the film of Example 1;

FIG. 2 shows the XRD patterns of the film of Example 16 first at various temperatures ranging from 600° C. to 1300° C.;

FIG. 3 shows a XRD pattern of the film of Reference Example 1;

FIG. 4 shows a graph depicting the relationship between firing temperature and percent shrinkage of films formed in Reference Examples 1 to 3; and

FIG. 5 shows the relationship between firing temperature and percent shrinkage of films formed in Reference Examples 4 to 8 and Comparative Reference Example 1.

### DETAILED DESCRIPTION

Disclosed herein is a method of producing an independent glass ceramic film containing a SiO₂ matrix glass and fine crystal ZrO₂ particles dispersed in the matrix glass.

The method disclosed herein is a sol-gel method. In some embodiments, extended drying times are not required. In some embodiments, cracking or deformation due to shrinkage generally does not occur. In some embodiments, films that are produced can advantageously be very flat. In some embodiments, films that are produced do not require support. In some embodiments, films that are produced herein have enhanced weather resistance, heat resistance, corrosion resistance and scratch resistance.

Methods as disclosed herein utilize a colloidal silica sol adjusted to be acidic that is mixed with a zirconium-containing compound such as zirconyl nitrate, a binder and a crosslinking agent to prepare a mixed liquid. This mixed liquid is then coated on a substrate and dried to form a precursor film on the substrate. Thereafter, the precursor film is separated from the substrate and fired, forming a glass ceramic having a SiO₂ glass with ZrO₂ fine crystals dispersed therein.

In an embodiment, the pH of the silica sol is adjusted to 4 or less before mixing it with the zirconium-containing compound. Forming a dispersion of the two before addition of other components is thought to aid in producing transparent independent films having fewer cracks. The binder is crosslinked by the crosslinking agent at a temperature of about 50° C. or less in order to suppress shrinkage during drying and firing. Shrinkage in turn can suppress deformation or cracking of the film. Because the film does not need to rely on a substrate for strength, the film has the flexibility of a thin film and can therefore be laminated to various substrates.

The first step in a method as disclosed herein is the preparation of a precursor mixture. A colloidal silica sol, a zirconium-containing compound, a binder, a crosslinking agent for the binder, and if desired, additives are mixed to prepare a precursor mixture. The precursor mixture is also referred to herein as a mixed liquid. Each of the components of the mixed liquid are described below.

Generally the colloidal silica sol is a colloidal silica sol having fine silica particles that are stably dispersed in a dispersion medium. Any dispersion medium generally utilized by one of skill in the art can be used. In embodiments where the dispersion medium is water the silica sol can generally be referred to as an aqueous silica sol. The diameter of the silica particles that are generally utilized are about 550 nm or less. In an embodiment, the diameter of the silica particles is about 300 nm or less. In an embodiment, the diameter of the silica particles is about 100 nm or less. If the diameter of the silica fine particles is excessively large, the film will generally not be transparent. Particle diameters that are too large can decrease the stability of the dispersion which can lead to an inhomogeneous sol and can make the voids between particles large; higher densification temperature are usually needed. In an embodiment the particle diameter of the silica fine particles is about 4 nm or more. Particle diameters that are too small can cause cracks to form which tend to make it difficult to form an independent film. The pH of the silica sol is made acidic before being added into the mixed liquid.

In an embodiment, the pH of the silica sol is adjusted to a pH of about 4 or less. In an embodiment, the pH of the silica sol is adjusted to a pH of about 3 or less. An acidic silica sol generally inhibits gelling or precipitation of the zirconium-containing compound and therefore maintains the homogeneous dispersion of the zirconium in the silica sol.

In an embodiment, commercially available colloidal silica that has previously been adjusted to be acidic may be used. In an embodiment where a neutral or alkaline colloidal silica is utilized, the pH of the colloidal silica sol may be made acidic by adding an acidic aqueous solution such as hydrochloric acid, nitric acid or acetic acid before mixing the zirconium-containing compound therewith. In embodiments where the colloidal silica sol is said to have a particular pH value, the pH can be determined immediately before mixing the sol with the zirconium-containing solution.

In preparing the mixed liquid, the colloidal silica sol is mixed with a zirconium-containing compound. The zirconium-containing compound is generally one that can produce a zirconium oxide (ZrO₂) fine crystal upon firing. In an embodiment, zirconyl nitrate or zirconyl acetate may be used for example. In an embodiment, zirconyl nitrate is utilized as it produces a dense, transparent film.

The zirconium-containing compound may be a solid, such as a powder. A solid zirconium-containing compound may be directly mixed with the other components of the mixed liquid or may be dissolved in water to form an aqueous solution and then mixed with the other components.

In an embodiment, the amount of zirconium-containing compound, in terms of the mass of ZrO₂, is at least about 10% and not more than about 60% based on the mass of the obtained silica-zirconium oxide (SiO₂+ZrO₂) independent glass ceramic film. As used herein, the term “independent glass ceramic film” refers to the fired film. In an embodiment, the amount of zirconium-containing compound, in terms of the mass of ZrO₂, is at least about 15% and not more than about 55% based on the mass of the obtained silica-zirconium oxide (SiO₂+ZrO₂) independent glass ceramic film. In an embodiment, the amount of zirconium-containing compound, in terms of the mass of ZrO₂, is at least about 20% and not more than about 50% based on the mass of the obtained silica-zirconium oxide (SiO₂+ZrO₂) independent glass ceramic film. If the amount of ZrO₂ added is too large, the film can crack easily during drying or firing.

The mixed liquid also includes a binder. The binder can include a water-soluble polymer such as, for example, polyvinyl alcohol, methyl cellulose, hydroxypropyl cellulose or polyvinylpyrrolidone.

The addition of an excessive amount of binder can enhance the strength of the precursor film before firing, but can also lead to excessive shrinkage thereby generating cracks during firing. Excessive amounts of binder can also increase production costs. In an embodiment, the amount of binder in terms of the mass of binder, is about 100% or less based on the mass of the obtained silica-zirconium oxide (SiO₂+ZrO₂) independent glass ceramic film. In an embodiment the amount of binder in terms of the mass of binder, is about 80% or less based on the mass of the obtained silica-zirconium oxide (SiO₂+ZrO₂) independent glass ceramic film. In an embodiment the amount of binder in terms of the mass of binder, is about 50% or less based on the mass of the obtained silica-zirconium oxide (SiO₂+ZrO₂) independent glass ceramic film. On the other hand, if there is not enough binder, the strength of the film before firing (referred to herein as a “green film”) is insufficient and the film is more likely to fracture when it is separated from the substrate prior to firing. In an embodiment, the amount of binder added, in terms of the mass of binder, is therefore generally from about 2 to about 100% based on the mass of the obtained silica-zirconium oxide (SiO₂+ZrO₂) independent glass ceramic film. In an embodiment, the amount of binder added, in terms of the mass of binder, is from about 5 to 50%, based on the mass of the obtained silica-zirconium oxide (SiO₂+ZrO₂) independent glass ceramic film.

The mixed liquid also includes a crosslinking agent capable of crosslinking the binder. The crosslinking agent may crosslink the binder at any time during the method. For example, the crosslinking agent may crosslink the binder during the preparation of the mixed liquid or during drying. In an embodiment, the crosslinking agent crosslinks the binder during the drying step. Accordingly, a crosslinking agent which can affect the crosslinking of the binder at a relatively low temperature can generally be utilized. In an embodiment, a crosslinking agent that can crosslink the binder at a temperature of about 50° C. or less is utilized. In an embodiment, a crosslinking agent that can crosslink the binder at a temperature of about 40° C. or less is utilized. In an embodiment, a crosslinking agent that can crosslink the binder at a temperature of about 30° C. or less is utilized. In an embodiment, a crosslinking agent that can crosslink the binder at a temperature of about room temperature is utilized. If the crosslinking agent is not added, the film can be easily deformed during the drying step. This deformation can increase during the drying step.

In an embodiment where the binder is polyvinyl alcohol, methyl cellulose or hydroxypropyl cellulose, the crosslinking agent can be a polyfunctional ketone such as diketone; an N-methylol compound; a polyaldehyde or aldehyde group-containing polymer; a polycarboxylic acid such as succinic acid or fumaric acid; a polyacrylic acid; a polyacrolein; an ammonium zirconium carbonate; or mixtures thereof for example. In an embodiment, the crosslinking agent can be a dialdehyde, an N-methylol compound, an ammonium zirconium carbonate or a mixture thereof. In an embodiment, the crosslinking agent can be glyoxal. In an embodiment where glyoxal is utilized as the crosslinking agent, it can crosslink the binder, for example polyvinyl alcohol, during drying at a temperature of about 20° C. to about 30° C. (e.g. at room temperature). Such low temperature crosslinking can suppress shrinkage due to drying.

In an embodiment, the amount of crosslinking agent added is about 50% by mass or less with respect to the mass of the binder. In an embodiment, the amount of crosslinking agent added is about 40% by mass or less with respect to the mass of the binder. In an embodiment, the amount of crosslinking agent added is about 30% by mass or less, with respect to the mass of the binder. In an embodiment, the amount of crosslinking agent added is about 0.1% by mass or more with respect to the mass of the binder. In an embodiment, the amount of crosslinking agent added is about 1% by mass or more with respect to the mass of the binder. In an embodiment, the amount of crosslinking agent added is about 5% by mass or more, with respect to the mass of the binder. If the amount of crosslinking agent added is too large, the organic content in the mixed liquid becomes high which can result in a large amount of shrinkage during firing and in some cases an inhomogeneous green film. If the amount of crosslinking agent added is too little, high crosslinking density in the green film and satisfactory green hardness cannot be obtained which can lead to excessive deformation during firing.

The mixed liquid may also optionally include organic additives. The organic additives can include alkanolamines such as triethanolamine, diethanolamine and monoethanolamine; polyhydric alcohols such as γ-butyrolactone, lactic acid, ethylene glycol, diethylene glycol, polyethylene glycol, glycerin and 1,4-butanediol; or polyhydric alcohol derivatives such as ethylene glycol monopropyl ether for example. In an embodiment, the organic additives can include an organic solvent that is compatible with water. In an embodiment, the organic solvent has a boiling point of about 100° C. or more so that some liquid remains after evaporation of water during drying. The compatibility of the solvent with water prevents an inhomogeneous structure from being formed.

In an embodiment, the amount of organic additive, if included, can be about 10% or more by mass, with respect to the mass of the binder. In another embodiment, the amount of organic additive, if included, can be about 20% or more by mass, with respect to the mass of the binder. In another embodiment, the amount of organic additive, if included, can be about 30% or more by mass, with respect to the mass of the binder. Addition of an organic additive can control the drying rate and can therefore control cracking of the precursor film. An organic additive can also provide flexibility to the precursor film to improve handling thereof If too much organic additive is added, drying of the film can be significantly retarded.

The mixed liquid may also optionally include an alkali metal compound or an alkaline earth metal compound. Such an optional compound can decrease the temperature necessary for firing. The alkali metal compound or alkaline earth metal compound if added, can be added to the sol, as a water-soluble compound or as an aqueous solution prepared by previously dissolving it in water. In an embodiment, the compound is a salt such as a nitrate or an acetate. If included, the compound can be added at about 20 mol % or less, based on the amount of SiO₂. In an embodiment, the compound, if added, is added at about 10 mol % or less, based on the amount of SiO₂. In an embodiment, the compound, if added is added at about 8 mol % or less, based on the amount of SiO₂. Addition of alkali or alkaline earth compound can decrease the firing temperature but too much can also induce cracking of the film during drying. Too much alkali or alkaline earth compound can also occasionally detrimentally affect the water resistance or mechanical strength of the independent glass film. The mass% of alkali metal or alkaline earth metal corresponding to 8 mol % is shown in Table 1 below.

TABLE 1

| Alkali Metal or Alkaline | Mass % in Terms of Oxide |
|---|---|
| Earth Metal | (corresponding to 8 mol %) |
| Na | 4.3 |
| K | 6.4 |
| Rb | 12 |
| Cs | 17 |
| Mg | 5.5 |
| Ca | 7.5 |
| Sr | 13 |

If the amount of alkali or alkaline earth compound added is too small it will have little or no effect. In an embodiment, about 1/30 or more of the amount shown in Table 1 of any of the alkali metal or alkaline earth metal compound can be added to have the desired effect. In an embodiment, about 1/20 or more of the amount shown in Table 1 of any of the alkali metal or alkaline earth metal compound can be added to have the desired effect. In an embodiment, about 1/10 or more of the amount shown in Table 1 of any of the alkali metal or alkaline earth metal compound can be added to have the desired effect. Other optional additives to affect the melting point of silica, other than the alkali metal compound and alkaline earth meal compound, may also be added. An example of such an additive includes boron compounds (e.g., boric acid). Transition metal or rare earth metals can also be added as optional additives. The amount of such additives, if included, is generally about 10 wt % or less based on the amount of SiO₂. If too much of an additive capable of decreasing the melting point is added, vitrification can occur before complete decomposition and volatilization of the organic matter, which can result in residual carbon remaining in the glass after firing.

The mixed liquid may also optionally include a surfactant. If included, the surfactant can be used to minimize contact between the precursor film and the substrate 2 5 and thereby facilitate separation of the precursor film from the substrate. The particular surfactant is not generally limited, and may include for example, polyoxyethylene alkylamine having good mixing stability with the silica sol.

Once the mixed liquid, or precursor mixture is prepared it is then coated on a substrate. Substrates as are commonly utilized by those of skill in the art may generally be used. Specific examples of material that may be utilized for the substrate include, but are not limited to, polyester films such as polyethylene terephthalate (PET); acryl films such as polymethyl methacrylate (PMMA); plastic films such as polycarbonate and polyimide; glass or ceramic sheets; and metal sheets. The substrate may be treated before the mixed liquid is coated thereon. For example, it may be subjected to a silicone treatment in order to facilitate separation of the precursor film from the substrate after drying. In an embodiment where a relatively thin film is to be formed, the substrate is generally not treated because it can sometimes affect the film-forming ability of the coating.

Coating of the precursor mixture on the substrate may be performed using techniques generally known to those of skill in the art, including for example, die coating, spray coating, bar coating, knife coating, casting, spin coating and screen printing.

After the mixed liquid is coated on the substrate it is dried to form a precursor film or green film. Drying can be performed at room temperature (about 25° C.) or at higher temperatures. Drying can occur at atmospheric pressure or at reduced pressures. In an embodiment utilizing drying at room temperature, several hours may be sufficient. In an embodiment, room temperature drying may be carried on longer. In an embodiment, room temperature drying takes place for about 24 hours or even for about 36 hours.

Once dried, the precursor film is then separated from the substrate. If desired, the precursor film may be cut to desired dimensions after being separated. The precursor film is separated before it is fired to avoid the generation of stress between the substrate and the precursor film caused by heating. Such stress can cause cracks to occur.

Once separated, the separated precursor film is then fired. In an embodiment, an 2 5 electric furnace can be used to fire the separated precursor film. The temperature of firing is generally one that can affect burn-out of the organic matter. Such an initial temperature can be from about 450° C. to about 500° C. In an embodiment, firing can include more than one temperature ramp. The rate at which the temperature is increased to the initial temperature, referred to herein as a temperature ramp or more specifically, an initial temperature ramp, can function to slowly dry the film. In an embodiment, the temperature can be increased at a rate of about 5° C./min. In an embodiment, the temperature can be increased at a rate of about 3° C./min. In an embodiment, the temperature can be increased at a rate of about 1° C./min.

Once the initial temperature has been obtained, the temperature can, but need not be increased at a higher rate, for example, from about 5° C./min to about 10° C./min. The final temperature that is obtained is generally referred to as the firing temperature. The firing temperature is generally from about 600° C. to about 1,300° C. If an optional alkali metal compound or an alkaline earth metal compound was included in the precursor mixture, the firing temperature can be lower. The precursor film is fired at the firing temperature for about 15 minutes or more, to form an independent glass ceramic film. Films obtained using methods disclosed herein can be analyzed using X-ray diffraction (XRD) analysis, tunneling electron microscope (TEM), or a combination thereof. Such analysis can confirm the presence of an SiO₂ matrix glass and fine crystal ZrO₂ particles dispersed therein. XRD analysis and TEM analysis have shown that films formed herein have ZrO₂ particles having diameters of about 100 nm or less. Films with such fine crystal ZrO₂ particles generally have enhanced scratch resistance and are transparent. Films produced using methods as disclosed herein can have thicknesses ranging from about 5 micrometers (μm) to about 2 millimeters (mm). In an embodiment, a flexible, organic, free standing (referred to herein as independent) film having a thickness of about 10 to about 100 μm can be formed. The thickness of films produced herein can be measured by observation through a microscope or through use of a micrometer.

In an embodiment, films produced herein can be utilized by laminating them to various other materials. Examples of material that the films can be laminated to include, but are not limited to, plastic films, metal, wood material, concrete, ceramic and the like. The materials that the films can be laminated to can be, but need not be, heat resistant. Examples of materials that are heat resistant include, but are not limited to, metal, concrete and ceramic. Examples of materials that are not heat resistant include, but are not limited to, plastic films and paper sheets. Lamination of the films to other materials can serve to enhance the heat resistance, scratch resistance, and/or chemical resistance. A film that has been densified during firing can be utilized to increase the gas barrier property of a material. A film that has been formed without significant densification can be used to thermally insulate a material.

In an embodiment, a film produced herein can be used in display devices such as plasma display panels (PDP) and liquid crystal display panels (LCP). Films produced herein can also offer advantages because they do not add much weight to devices that are advantageously lightweight.

### Examples

The disclosure is described in a non-limiting fashion by the examples that follow. Unless otherwise indicated percentages given herein are based on weight.

### Example 1

Snowtex ST-O, having a particle diameter of 10 to 20 nm, and a solid content of 20.5 wt %, (Nissan Chemicals Industries, Ltd., Tokyo, Japan) was used as the colloidal silica sol. The pH of the Snowtex ST-O was determined to be about 2.8 by sampling tens of milliliters of the sample and measuring the pH using a commercially available portable checker (CHECKER®, Hanna Instruments, Woonsocket, R.I.).

1.0 g of zirconyl nitrate dihydrate (Wako Pure Chemical Industries, Ltd., Tokyo, Japan) was dissolved in 1.9 g of distilled water to form a zirconyl nitrate aqueous solution. 1.15 g of the zirconyl nitrate aqueous solution was mixed with 2.1 g of the colloidal silica sol to obtain a zirconyl nitrate-containing silica sol. An aqueous calcium nitrate solution was separately prepared by dissolving 1.29 g of calcium nitrate tetrahydrate (Wako Pure Chemical Industries, Ltd., Tokyo, Japan) in 18.7 g of distilled water. 1.15 g of the resulting aqueous calcium nitrate solution was mixed with the zirconyl nitrate-containing silica sol (corresponding to about 4.2 mol % of CaO₂ based on SiO₂). Separately, polyvinyl alcohol (Kuraray Poval PVA-105) (produced by Kuraray Co., Ltd., Tokyo, Japan) was dissolved in distilled water to prepare a 5% polyvinyl alcohol binder solution. 0.6 g of 2-aminoethanol (Wako Pure Chemical Industries, Ltd., Tokyo, Japan) was dissolved in 1.8 g of water, and the resulting solution was neutralized by gradually adding 1.8 g of acetic acid (Wako Pure Chemical Industries, Ltd., Tokyo, Japan) to prepare an aminoethanol solution. 0.045 g of triethylene glycol, 0.02 g of the surfactant AMIET 105 (produced by Kao Corporation, Tokyo, Japan) and 0.03 g of the aminoethanol solution prepared above were added to 2 g of the 5% polyvinyl alcohol binder solution. This resulted in adding 45% (by mass) of triethylene glycol based on the mass of the polyvinyl alcohol. 4.4 g of the zirconyl nitrate-containing silica sol solution was then added and 0.3 g of a 10% glyoxal solution was added to obtain a mixed liquid. This solution resulted in 30% (by mass) of glyoxal based on the mass of the polyvinyl alcohol.

The resulting mixed liquid was cast on a LUMIRROR® polyethylene terephthalate (PET) film (Toray Industries, Inc., Tokyo, Japan) and dried overnight at room temperature. The dried precursor film was separated from the PET film, placed on an alumina substrate and fired in an electric furnace. The firing consisted of gradually increasing the temperature from room temperature to 500° C. over 10 hours to remove the binder, then elevating the temperature from 500° C. to 800° C. over about 1 hour and further elevating to 950° C. over 3 hours. The film was finally fired at 950 C for 1 hour.

After firing, the film had a rectangular shape of about 30 mm×50 mm. Deformation was characterized by measuring a distortion angle, which is defined as an angle made by the fired sample and a flat surface. The fired film was place on a flat substrate. One of the short edges (30 mm side) was pushed down to contact the flat surface. The angle made by flat surface and the other short edge of the sample was measured.

Table 2 provides the meaning of the various degrees of deformation that are utilized when reporting results. As seen there, when the distortion angle is nearly 0°, the film was judged almost flat and the degree of deformation was rated “0”.

TABLE 2

| Degree of | |
|---|---|
| Deformation | |
| 5 | The sample was greatly deformed and showed a |
| | deformation of 240° to roll (360°) or more. |
| 4 | The sample was greatly deformed and showed a |
| | deformation of 180° to 240° after firing. |
| 3 | The sample showed a deformation of 90 to 180° |
| | after firing. |
| 2 | The sample showed a medium deformation of 30 to 90° |
| | after firing. |
| 1 | The sample showed a small deformation of 10 to 30° |
| | after firing. |
| 0 | The sample was almost flat after firing and the |
| | distoration angle was nearly 0°. |

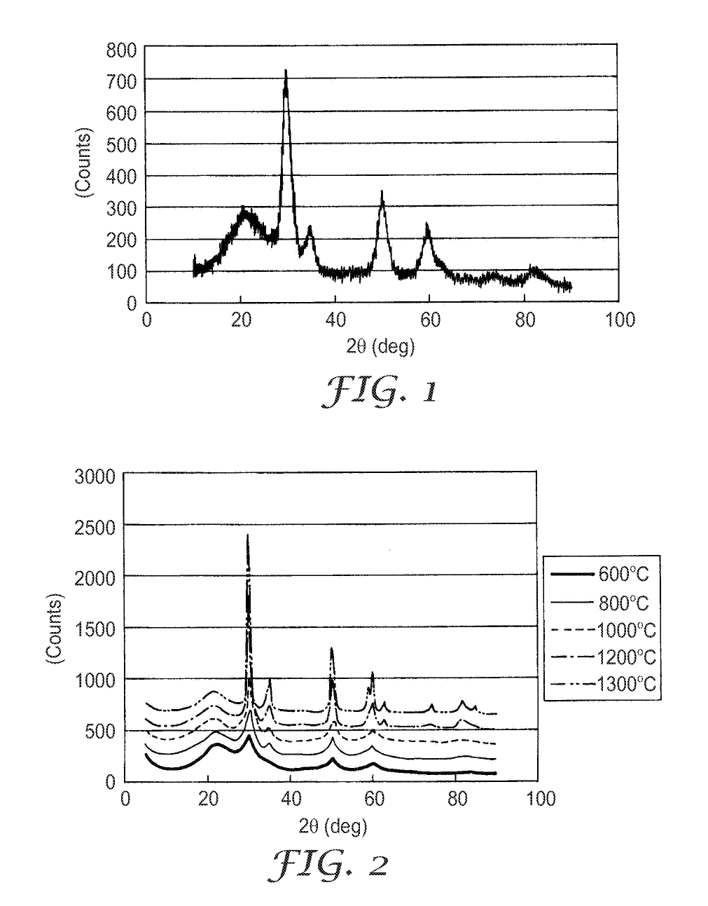

A plurality of films produced as described above were all transparent with little deformation (degrees of deformation were from 0 to 1). The approximate thickness of the effective portion (e.g., a portion without wrinkles) was calculated from the average of three measurements using a micrometer. The thickness was about 50 μm. XRD analysis confirmed that the transparent fired sample contained fine crystal t-ZrO₂ in an SiO₂ matrix. FIG. 1 shows the XRD pattern of the film. The particle diameter of the fine crystal t-ZrO₂ was determined from the peak of the XRD and by direct observation via the TEM image to be about 5 to 8 nm. The film was flexible enough to sag when pressure was applied to it by hand.

### Comparative Example 1

Independent films were produced according to Example 1 except that no glyoxal was added. XRD analysis showed that the transparent fired samples had fine crystals of ZrO₂ dispersed in a SiO₂ matrix. The films were somewhat flexible but the degree of deformation varied greatly among a plurality of films from 2 to 5. Most of the samples showed a degree of deformation of 4 or 5.

The films produced in Example 1 were less deformed when compared with the film produced in Comparative Example 1. It is thought that this was due to the polyvinyl alcohol being crosslinked by the glyoxal.

### Examples 2 to 4

Independent films were produced according to Example 1 except that the amount of the glyoxal solution added was changed from 0.3 g (Example 1) to 0.2 g, 0.5 g and 0.7 g (Examples 2, 3 and 4 respectively). The films were transparent. XRD analysis confirmed that the transparent fired samples contained t-ZrO₂ fine crystals. The films were flexible enough to sag when pressure was applied to it by hand. The films had a degree of deformation of either 0 or 1 and were relatively flat.

### Examples 5 to 8

Independent films were produced according to Example 1 except that the particular glycols shown in Table 3 were added in place of triethylene glycol.

The fired films were transparent and XRD analysis confirmed that the fired samples contained t-ZrO₂ fine crystals. The films were flexible enough to sag when pressure was applied to it by hand. The films had a degree of deformation of either 0 or 1 and were relatively flat.

### Example 9

An independent film was produced according to Example 1 except that polyethylene glycol #2000 (molecular weight=2000 g/mol) (Wako Pure Chemical Industries, Ltd., Tokyo, Japan) was added in place of the triethylene glycol. The film was subjected to XRD analysis and it was confirmed that the fired sample contained t-ZrO₂ fine crystal. The film was slightly hazy but flexible enough to sag when pressure was applied to it by hand. The films had degrees of deformation of nearly 0 and were almost flat.

### Examples 10 to 12

Independent films were produced according to Example 1 except that the glyoxal 2 0 was replaced by glutaraldehyde (dialdehyde) in Example 10; by AZ Coat 5800 MT (a composition of which the main component is ammonium zirconium carbonate) (San Nopco Limited, Kyoto City, Japan) in Example 11; and by Bekkamin M-3 (a composition of which the main component is N-methylol) (Dainippon Ink & Chemicals, Inc., Tokyo, Japan) in Example 12. The amounts of the three compounds are shown in Table 3.

Independent films were transparent and it was confirmed by XRD analysis that the fired samples contained t-ZrO₂ fine crystals. The films were slightly hazy but were flexible enough to sag when pressure was applied to it by hand. The degrees of deformation of the films after firing were from 2 to 4, and most of the samples had degrees of deformation of 2 or 3. As seen in Table 3, the deformation of these samples was less than that seen in the film of Comparative Example 1 where the crosslinking agent was not added.

### Comparative Example 2

An independent film was produced according to Comparative Example 1 except that the green film, once separated from the PET film was sandwiched between two alumina substrates (thickness: 0.8 mm). The fired film was transparent and it was confirmed by XRD analysis that the fired sample contained t-ZrO₂ fine crystals. The film had a degree of deformation of nearly 0 and was a flat film, but included many cracks.

### Example 13

An independent film was produced according to Example 1 except that the green film once separated from the PET film was sandwiched between two alumina substrates (thickness: 0.8 mm). The fired film was transparent and it was confirmed by XRD analysis that the fired sample contained t-ZrO₂ fine crystals. The film had a degree of deformation of nearly 0 and was a flat film. Cracks were not generated in the film.

### Example 14

An independent film was produced according to Example 1 except that an aqueous potassium nitrate solution (in terms of the oxide, corresponding to about 4.2 mol % based on SiO₂) was used in place of the aqueous calcium nitrate solution. The fired film was transparent and it was confirmed by XRD analysis that the fired sample contained t-ZrO₂ fine crystals. The film was flexible enough to sag when pressed with a hand. A plurality of the films had a degree of deformation of either 0 or 1 and were relatively flat.

### Example 15

An independent film was produced according to Example 14 except that boric acid was added in the same mole % as the potassium nitrate. The fired film was transparent and it was confirmed by the XRD analysis that the fired sample contained t-ZrO₂ fine crystals. The film was flexible enough to sag when pressure was applied to it by hand. A plurality of the films had a degree of deformation of either 0 or 1 and were relatively flat.

### Example 16

An independent film was produced according to Example 1 except that the aqueous calcium nitrate solution was not added and the final firing temperature was 600° C., 800° C., 1,000° C., 1,200° C. and 1,300° (instead of 950° C. as it was in Example 1). The firing was carried out by elevating the temperature from room temperature to 500° C. over 10 hours, keeping it at 500° C. for 1 hour, then elevating the temperature to the final temperature over 1 hour, and maintaining the final temperature for 1 hour.

A plurality of films produced under the above-described conditions were all transparent with minimal deformation (degree of deformation: from 0 to 1). The films were measured (using a micrometer) at several portions (e.g., measured in three locations and averaged) to determine that the approximate thickness of the effective portion. The average thickness was about 50 μm. XRD analysis confirmed that the transparent films contained t-ZrO₂ fine crystals. FIG. 2 shows the diffraction pattern of the film. The particle diameter of the fine crystal t-ZrO₂ (determined from the peak of the XRD) was confirmed by directly observing the TEM image to be approximately 5 to 8 nm. The film was flexible enough to sag when pressure was applied to it by hand.

TABLE 3

| | | % Crosslinking | | % Organic | | | |
|---|---|---|---|---|---|---|---|
| | | Agent (by mass) | | Additive (by mass) | Alkali Metal | Mol % (in terms | |
| Example | Crosslinking | with respect | | with respect | or Alkaline | of oxide) Based | Degree of |
| No. | Agent | to Binder | Organic Additive | to Binder | Earths | on SiO₂ | Deformation |
| 1 | glyoxal | 30 | triethylene glycol | 45 | Ca | 4.2 | 0 to 1 |
| 2 | glyoxal | 20 | triethylene glycol | 45 | Ca | 4.2 | 0 to 1 |
| 3 | glyoxal | 50 | triethylene glycol | 45 | Ca | 4.2 | 0 to 1 |
| 4 | glyoxal | 70 | triethylene glycol | 45 | Ca | 4.2 | 0 to 1 |
| 5 | glyoxal | 30 | diethylene glycol | 45 | Ca | 4.2 | 0 to 1 |
| 6 | glyoxal | 30 | tetraethylene glycol | 45 | Ca | 4.2 | 0 to 1 |
| 7 | glyoxal | 30 | pentaethylene glycol | 45 | Ca | 4.2 | 0 to 1 |
| 8 | glyoxal | 30 | Polyethylene | 45 | Ca | 4.2 | 0 to 1 |
| | | | glycol #200 | | | | |
| 9 | glyoxal | 30 | polyethylene | 45 | Ca | 4.2 | 0 |
| | | | glycol #2000 | | | | |
| 10 | glutaraldehyde | 2 | triethylene glycol | 45 | Ca | 4.2 | 2 to 4 |
| | (dialdehyde) | | | | | | (mainly 2 or 3) |
| 11 | ammonium | 2 | triethylene glycol | 45 | Ca | 4.2 | 2 to 4 |
| | zirconium | | | | | | (mainly 2 or 3) |
| | carbonate | | | | | | |
| 12 | N-methylol | 2 | triethylene glycol | 45 | Ca | 4.2 | 2 to 4 |
| | | | | | | | (mainly 2 or 3) |
| 13 | glyoxal | 30 | triethylene glycol | 45 | Ca | 4.2 | 0* |
| 14 | glyoxal | 30 | triethylene glycol | 45 | K | 4.2 | 0 to 1 |
| 15 | glyoxal | 30 | triethylene glycol | 45 | (boric acid) | 4.2 | 0 to 1 |
| 16 | glyoxal | 30 | triethylene glycol | 45 | none | 0 | 0 to 1 |
| Comparative | none | 0 | triethylene glycol | 45 | Ca | 4.2 | 2 to 5 |
| Example 1 | | | | | | | (mainly 4 or 5) |
| Comparative | none | 0 | triethylene glycol | 45 | Ca | 4.2 | 0* |
| Example 2 | | | | | | | (cracked) |

*In Example 13 and Comparative Example 2, the film was sandwiched by two alumina substrates and fired. Cracks were not generated in Example 13, but were generated in Comparative Example 2.

In Reference Examples 1 through 20 below, the agent to crosslink the binder was not added. The presence or absence of the crosslinking agent does not affect the temperature required for firing, so these examples were utilized to determine how firing changes when an alkali metal compound or an alkaline earth metal compound is added.

### Reference Example 1

### Addition of Alkaline Earth Metal Compound

Snowtex ST-O, having a particle diameter of 10 to 20 nm, and a solid content of 20.5 wt %, (Nissan Chemicals Industries, Ltd., Tokyo, Japan) was used as the colloidal silica sol. The pH of the Snowtex ST-O was determined to be about 2.8 through use of a commercially available portable checker (CHECKER®, Hanna Instruments, Woonsocket, R.I.).

1.0 g of zirconyl nitrate dihydrate (Wako Pure Chemical Industries, Ltd., Tokyo, Japan) was dissolved in 1.9 g of distilled water to form a zirconyl nitrate aqueous solution. 1.15 g of the zirconyl nitrate aqueous solution was mixed with 2.1 g of the Snowtex colloidal silica sol to obtain a zirconyl nitrate-containing sol. An aqueous calcium nitrate solution was separately prepared by dissolving 1.29 g of calcium nitrate tetrahydrate (Wako Pure Chemical Industries, Ltd., Tokyo, Japan) in 18.7 g of distilled water. 1.15 g of the resulting aqueous calcium nitrate solution was mixed with the zirconyl nitrate-containing silica sol (corresponding to about 4.2 mol % of CaO₂ based on SiO₂). Separately, polyvinyl alcohol (Kuraray Poval PVA-105) (produced by Kuraray Co., Ltd., Tokyo, Japan) was dissolved in distilled water to prepare a 5% polyvinyl alcohol binder solution. 0.6 g of 2-aminoethanol (Wako Pure Chemical Industries, Ltd., Tokyo, Japan) was dissolved in 1.8 g of water, and the resulting solution was neutralized by gradually adding 1.8 g of acetic acid (Wako Pure Chemical Industries, Ltd., Tokyo, Japan) to prepare an aminoethanol solution. 0.045 g of triethylene glycol, 0.02 g of the surfactant AMIET 105 (produced by Kao Corporation, Tokyo, Japan) and 0.03 g of the aminoethanol solution prepared above were added to 3 g of the 5% polyvinyl alcohol binder solution. This resulted in adding 45% (by mass) of triethylene glycol based on the mass of polyvinyl alcohol. 4.4 g of the zirconyl nitrate-containing silica sol solution was then added and 0.3 g of a 10% glyoxal solution was added to obtain a mixed liquid.

The resulting mixed liquid was cast on a LUMIRROR® polyethylene terephthalate (PET) film (Toray Industries, Inc., Tokyo, Japan) and dried overnight at room temperature. The dried precursor film was separated from the PET film, placed on an alumina substrate and fired in an electric furnace. The firing consisted of gradually increasing the temperature from room temperature to 500° C. over 3 hours to remove the binder, then elevating the temperature from 500° C. to 950° C. over about 1 hour. The temperature was held at 950° C. for 1 hour.

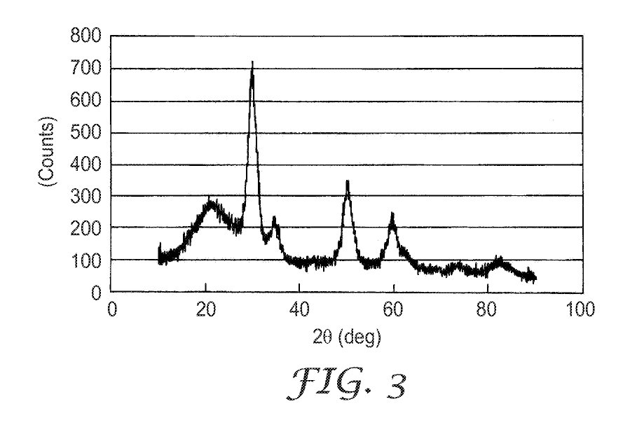

The film was measured (using a micrometer) at several portions (e.g., at least three) to determine that the approximate thickness of the effective portion. The average thickness about 50 μm. XRD analysis confirmed that the transparent films contained t-ZrO₂ fine crystals. FIG. 3 shows the diffraction pattern of the film. The particle diameter of the fine crystal t-ZrO₂ (determined from the peak of the XRD) was confirmed by directly observing the TEM image to be approximately 5 to 8 nm. The film was flexible enough to sag when pressure was applied to it by hand.

### Reference Examples 2 to 20 and Comparative Reference Example 1

Independent glass films were produced according to Reference Example 1 except that the compounds in Table 4, in the amounts shown, were added in place of the calcium compound. The results are shown in Table 4 below.

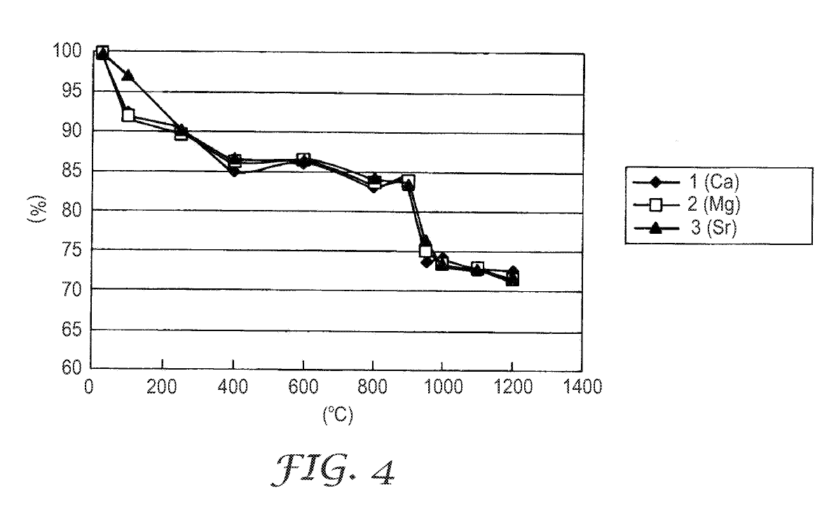

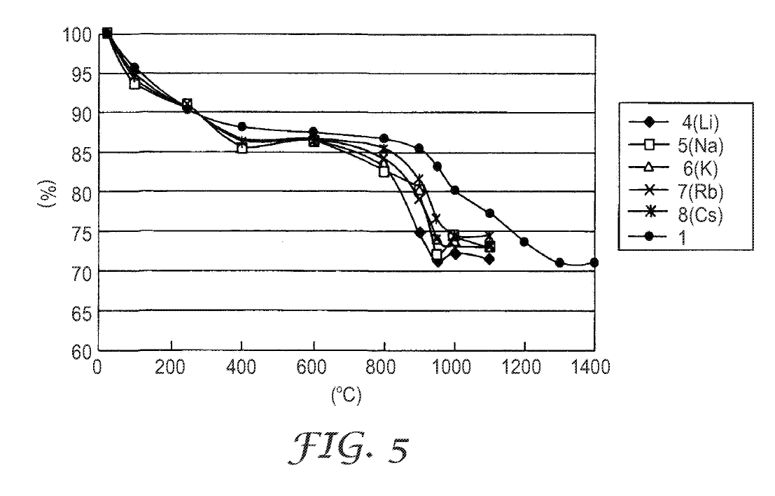

The samples were measured before firing and after firing and the percent shrinkage was determined ((dimension after firing/dimension before firing)×100). FIGS. 4 and 5 show the results. It was found that when an alkaline earth metal compound (4.2 mol %) is added, the densification temperature is from 950 to 1,000° C. and when an alkali metal compound (4.2 mol %) is added, the densification temperature is from 900 to 1,000° C. Also, it was found that when neither an alkaline earth metal compound nor an alkali metal compound is added, shrinkage continues until a higher temperature of 1,300° C. and the densification temperature is 1,300° C. or more.

TABLE 4

| | | | | Outer | | | Crystal |
|---|---|---|---|---|---|---|---|
| Reference | Compound | Amount | Firing | Appearance | Results of | Densification | Particle |
| Example | Added | Added (wt %) | Temp. (° C.) | after Firing | XRD | Temp. (° C.) | Size (nm) |
| 1 | Ca(NO₃)₂ | 3.9 | 950 | transparent film | t-ZrO₂ | 950 to 1000 | 5 to 8 |
| 2 | Mg(NO₃)₂ | 2.8 | 950 | transparent film | t-ZrO₂ | 950 to 1000 | 5 to 8 |
| 3 | Sr(NO₃)₂ | 7 | 950 | transparent film | t-ZrO₂ | 950 to 1000 | 5 to 8 |
| 4 | LiNO₃ | 1.1 | 900 | transparent film | t-ZrO₂ | 900 to 1000 | — |
| 5 | NaNO₃ | 2.2 | 950 | transparent film | t-ZrO₂ | 900 to 1000 | — |
| 6 | KNO₃ | 3.3 | 950 | transparent film | t-ZrO₂ | 900 to 1000 | — |
| 7 | RbNO₃ | 6.4 | 950 | transparent film | t-ZrO₂ | 900 to 1000 | — |
| 8 | CsNO₃ | 9.3 | 950 | transparent film | t-ZrO₂ | 900 to 1000 | — |
| Comparative | none | 0 | 950 | transparent film | t-ZrO₂ | 1300 or more | — |
| Reference | | | | | | | |
| Example 1 | | | | | | | |
| 9 | NaNO₃/ | Na₂O = 1.1, | 950 | transparent film | t-ZrO₂ | 950 to 1000 | 5 to 8 |
| | Ca(NO₃)₂ | CaO = 2 | | | | | |
| 10 | KNO₃/ | K₂O = 1.7, | 950 | transparent film | t-ZrO₂ | 950 to 1000 | 5 to 8 |
| | Ca(NO₃)₂ | CaO = 2 | | | | | |
| 11 | Ca(NO₃)₂ | 5.8 | 950 | transparent film | t-ZrO₂ | 950 | 5 to 8 |
| 12 | Ca(NO₃)₂ | 2 | 950 | transparent film | t-ZrO₂ | 1000 | 5 to 8 |
| 13 | KNO₃ | 0.63 | 950 | transparent film | t-ZrO₂ | 950 to 1000 | 5 to 8 |
| 14 | KNO₃ | 1.7 | 950 | transparent film | t-ZrO₂ | 950 to 1000 | 5 to 8 |
| 15 | KNO₃ | 3.9 | 950 | transparent film | t-ZrO₂ | 950 to 1000 | 5 to 8 |
| 16 | KNO₃ | 4.9 | 950 | transparent film | t-ZrO₂ | 950 to 1000 | 5 to 8 |
| 17 | KNO₃/ | K₂O = 0.4, | 950 | transparent film | t-ZrO₂ | 1000 | 5 to 8 |
| | Ca(NO₃)₂ | CaO = 0.3 | | | | | |
| 18 | KNO₃/ | K₂O = 1.0, | 950 | transparent film | t-ZrO₂ | 1000 | 5 to 8 |
| | Ca(NO₃)₂ | CaO = 0.9 | | | | | |
| 19 | KNO₃/ | K₂O = 2.3, | 950 | transparent film | t-ZrO₂ | 1000 | 5 to 8 |
| | Ca(NO₃)₂ | CaO = 2.0 | | | | | |
| 20 | KNO₃/ | K₂O = 2.9, | 950 | transparent film | t-ZrO₂ | 1000 | 5 to 8 |
| | Ca(NO₃)₂ | CaO = 2.4 | | | | | |

Note:
The amount added is an amount in terms of the oxide, based on SiO₂.

Embodiments of methods of producing independent glass films are disclosed. One skilled in the art will appreciate that the present disclosure can be practiced with embodiments other than those disclosed. The disclosed embodiments are presented for purposes of illustration and not limitation, and the present disclosure is limited only by the claims that follow.

We claim:

1. A method for producing an independent glass ceramic film, comprising:
mixing:
a colloidal silica sol, having a pH of about 4 or less;
a zirconium-containing compound;
a binder; and
a crosslinking agent capable of crosslinking with the binder at a temperature of about 50° C. or less, to produce a mixed liquid;
coating the mixed liquid on a substrate;
drying the coated mixed liquid to form a precursor film on the substrate;
separating the precursor film from the substrate; and
firing the separated precursor film to produce an independent glass ceramic film.

2. The method according to claim 1, wherein the crosslinking agent can crosslink with the binder at a temperature of about 20° C. to about 30° C.

3. The method according to claim 1 or 2, wherein the binder comprises polyvinyl alcohol and the crosslinking agent comprises a dialdehyde, an N-methylol compound, an ammonium zirconium carbonate or a combination thereof

4. The method according to claim 3, wherein said crosslinking agent comprises glyoxal.

5. The method according to any one of claims 1 to 4, wherein said zirconium-containing compound comprises zirconyl nitrate, zirconyl acetate, or a combination thereof.

6. The method according to any one of claims 1 to 5, wherein the mixed liquid further comprises an alkali metal compound, an alkaline earth metal compound, or a combination thereof.

7. The method according to any one of claims 1 to 6, wherein the mixed liquid further comprises an organic solvent that is compatible with water and has a boiling point of about 100° C. or more.

8. The method according to claim 7, wherein the organic solvent comprises an alkanolamine, a lactic acid, a polyhydric alcohol, or a combination thereof.

9. The method according to claim 1, wherein the coated mixed liquid is dried at room temperature.

10. The method according to claim 1, wherein the firing is accomplished using more than one temperature ramp.

11. A precursor mixture for the production of an independent glass ceramic film comprising:
a colloidal silica sol adjusted, having a pH of 4 or less;
a zirconium-containing compound;
a binder; and
a crosslinking agent capable of crosslinking with the binder at a temperature of about 50° C. or less.

12. The precursor mixture according to claim 11, wherein the crosslinking agent can crosslink with the binder at a temperature of about 20° C. to about 30° C.

13. The precursor mixture according to claim 11 or 12, wherein the binder comprises polyvinyl alcohol and the crosslinking agent comprises a dialdehyde, an N-methylol compound, an ammonium zirconium carbonate or a combination thereof.

14. The precursor mixture according to claim 13, wherein said crosslinking agent comprises glyoxal.

15. The precursor mixture according to any one of claims 11 to 14, wherein said zirconium-containing compound comprises zirconyl nitrate, zirconyl acetate, or a combination thereof.

16. The precursor mixture according to any one of claims 11 to 15, wherein the mixed liquid further comprises an alkali metal compound, an alkaline earth metal compound, or a combination thereof.

17. The precursor mixture according to any one of claims 11 to 16, wherein the mixed liquid further comprises an organic solvent that is compatible with water and has a boiling point of about 100° C. or more.

18. The precursor mixture according to claim 17, wherein the organic solvent comprises an alkanolamine, a lactic acid, a polyhydric alcohol, or a combination thereof.
